(19) United States
(12) Patent Application Publication
(10) Pub. No.: US 2026/0132882 A1
(43) Pub. Date: May 14, 2026

(54) ADJUSTABLE MONITOR STAND SYSTEM AND CONTROL METHOD THEREOF

(71) Applicant: Peter Kao, City of Industry, CA (US)

(72) Inventor: Peter Kao, City of Industry, CA (US)

(21) Appl. No.: 18/944,613

(22) Filed: Nov. 12, 2024

(51) Int. Cl. F16M 11/04; G01B 11/14

(52) U.S. Cl. CPC F16M 11/048; G01B 11/14

(57) ABSTRACT

An adjustable monitor stand system includes a base, a work platform, and a driving module. The work platform is slidable relative to the base. The driving module is secured to the base and includes a control circuit and a horizontal transmission mechanism. The control circuit can receive a set distance and a set time. The horizontal transmission mechanism is coupled to the work platform and can move the work platform relative to the base in a forward or backward direction based on the set distance and the set time. A method for controlling an adjustable monitor stand system is also disclosed.

### FIELD OF THE INVENTION

The present invention generally relates to a monitor stands, more particularly, to an adjustable monitor stand system.

### BACKGROUND OF THE INVENTION

In modern digital age, prolonged computer usage has become commonplace in both professional and personal settings. This has led to increased concerns about ergonomics and the health implications of extended screen time. Conventional monitor stands often lack adjustable features that cater to individual user needs, such as varying heights, distances, and viewing angles. While some adjustable monitor stands exist, they typically require manual adjustments, which can be inconvenient and disrupt workflow.

Moreover, conventional monitor stands are usually configured to adjust to a specific setting before the user begins using the monitor. They lack the capability to make adaptive adjustments in response to the user's real-time needs.

### SUMMARY OF THE INVENTION

In order to overcome the disadvantages associated with the aforementioned monitor stand, an adjustable monitor stand system is disclosed. The adjustable monitor stand system includes a base, a work platform, and a driving module. The work platform is slidable relative to the base. The driving module is secured to the base and includes a control circuit and a horizontal transmission mechanism. The control circuit can receive a set distance and a set time. The horizontal transmission mechanism is coupled to the work platform. The horizontal transmission mechanism can move the work platform relative to the base in a forward or backward direction based on the set distance and the set time.

The adjustable monitor stand system may be configured such that the horizontal transmission mechanism includes a top layer, a bottom layer, a sliding element, and a motor. The top layer is secured to the work platform. The bottom layer is secured to the base. The sliding element is mounted on the top layer and slidable relative to the bottom layer. The motor is coupled to the sliding element. The motor can control a movement of the top layer.

The adjustable monitor stand system may be configured such that the base further includes an optical sensor. The optical sensor is electrically coupled to the control circuit. The optical sensor can detect a user in front of the base. The control circuit can deactivate a movement of the work platform in the absence of the user, and automatically activate the movement when the user is detected.

The adjustable monitor stand system may be configured such that the base further includes an optical sensor. The optical sensor is electrically coupled to the control circuit. The optical sensor can detect a distance between the base and the user. The control circuit can compare the distance to a predefined minimum distance. The control circuit can move the work platform in the backward direction if the distance is less than the predefined minimum distance.

The adjustable monitor stand system may be configured such that the base further includes an optical sensor. The optical sensor is electrically coupled to the control circuit. The optical sensor can detect a user in front of the base. The control circuit can move the work platform back and forth twice by a short distance when the optical sensor detects that the user has been in front of the base for longer than a set duration to remind the user to take a break.

In another aspect, a method for controlling an adjustable monitor stand system is provided. The method includes steps of receiving a set distance and a set time, and moving a work platform relative to a base in a forward or backward direction based on the set distance and the set time.

The method may further include steps of detecting a user in front of the base, deactivating a movement of the work platform in absence of the user, and automatically activating the movement when the user is detected.

The method may further include steps of detecting a distance between the base and the user, comparing the distance to a predefined minimum distance, and moving the work platform in the backward direction if the distance is less than the predefined minimum distance.

The step of receiving the set distance may further include receiving a forward distance and a backward distance.

The method may further include a step of moving the work platform back and forth twice by a short distance when detecting that the user has been in front of the base for longer than a set duration to remind the user to take a break.

### BRIEF DESCRIPTION OF THE DRAWINGS

The drawings illustrate examples. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 shows a perspective view of an embodiment of an adjustable monitor stand system.

FIG. 2 shows a perspective view of the adjustable monitor stand system shown in FIG. 1, where a work platform slides in a forward direction.

FIG. 3 shows a perspective view of the adjustable monitor stand system shown in FIG. 1, where the work platform slides in a backward direction.

FIG. 4 shows a perspective view of the adjustable monitor stand system shown in FIG. 1.

FIG. 5 shows an exploded perspective view of an embodiment of a driving module shown in FIG. 4.

FIG. 6 shows a flowchart of an embodiment of a method for controlling an adjustable monitor stand system.

### DETAILED DESCRIPTION OF THE PREFERRED EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

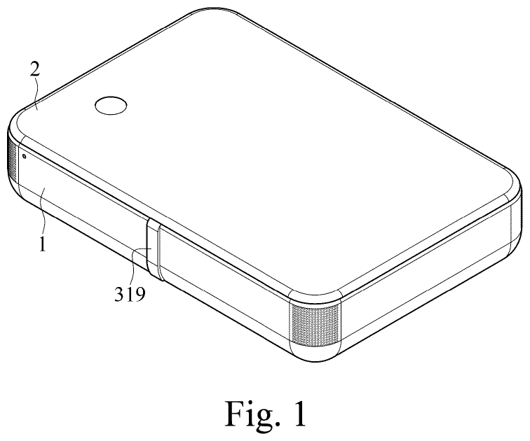

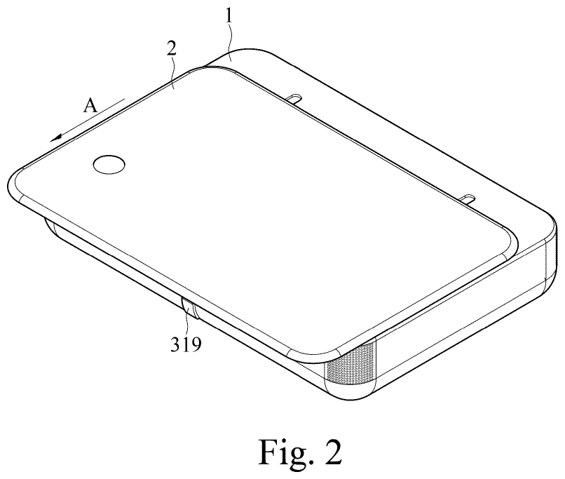

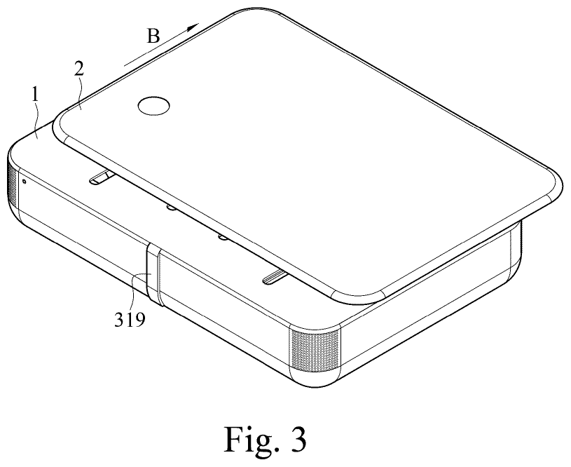

FIGS. 1 through 6 are perspective views of an embodiment of an adjustable monitor stand system. Referring to FIG. 1, the adjustable monitor stand system includes a base 1, a work platform 2, and a driving module 3. The work platform 2 can be used to support a monitor. The work platform 2 is slidable relative to the base 1. In this embodiment, the work platform 2 can slide in a forward direction A or in a backward direction B, respectively, in FIGS. 2 and 3.

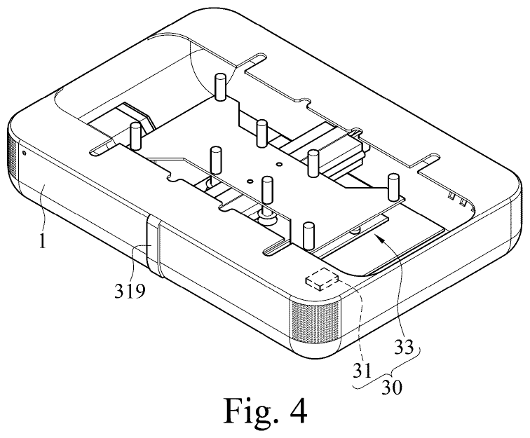

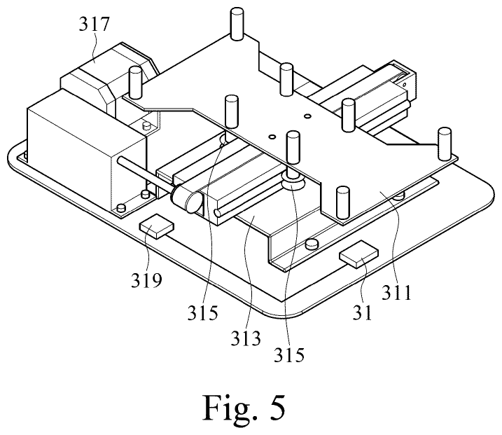

Referring to FIGS. 4 and 5, in this embodiment, the driving module 3 is secured to the bottom of the base 1. The driving module 3 includes a control circuit 31 and a horizontal transmission mechanism 33. The control circuit 31 can receive a set distance and a set time. These parameters can be stored in a memory unit electrically coupled with the control circuit 31, allowing the user to input the parameters in advance.

The horizontal transmission mechanism 33 is coupled to the work platform 2 and electrically coupled to the control circuit 31. The horizontal transmission mechanism 33 can receive the set distance and the set time from the control circuit 31. The horizontal transmission mechanism 33 can move the work platform 2 relative to the base 1 in either the forward direction A or the backward direction B, based on the set distance and set time, as shown in FIGS. 2 and 3.

In one embodiment, the set time is, but is not limited to, intervals of 15 minutes. This allows the work platform 2 to move back and forth at the set time interval. Additionally, in some embodiments, the set distance may be defined as separate forward and backward distances. For instance, the forward distance is 6 cm, while the backward distance is 8 cm, although other distances may be used.

As such, the adjustable monitor stand system can effectively promote eye health and comfort by dynamically adjusting the monitor's position relative to the user. By allowing the work platform to slide forward and backward based on predefined distance and time settings, the system realizes regular changes in the user's viewing distance from the monitor on the work platform. This adjustment prompts the eyes to frequently shift focus, engaging the lens and suspensory ligaments and preventing them from remaining in a fixed, tense state for extended periods. Consequently, the system helps alleviate common symptoms of prolonged screen use, such as eye fatigue, dry eyes, and blurred vision, and may reduce the risk of long-term vision issues, supporting a more ergonomic and user-friendly experience.

Referring to FIGS. 4 and 5 again, in one embodiment, the horizontal transmission mechanism 33 includes a top layer 331, a bottom layer 333, a sliding element 335, and a motor 337. The top layer 331 is secured to the underside of the work platform 2, while the bottom layer 333 is secured to the base 1.

The sliding element 335 is mounted on the top layer 311 and extends toward the bottom layer 333. Accordingly, the sliding element 335 is disposed between the top layer 331 and the bottom layer 333. This allows the top layer 331 to slide smoothly relative to the bottom layer 333. The sliding element 335 may include bearings, low-friction materials, or linear guides such as cylindrical rails to facilitate smooth movement. Referring to FIG. 4, in one embodiment, there are four sliding elements 335 disposed on both sides of a central track corresponding to two cylindrical rails.

The motor 337 can be directly or indirectly coupled to the sliding element 335. Thus, the motor 337 can control the movement of the top layer 331 by transmitting power through the sliding elements 335. When activated by the control circuit 31, the motor 337 drives the sliding element 335, causing the work platform 2 to move forward or backward relative to the base 1. For instance, as shown in FIG. 2, the work platform 2 moves in the forward direction A, bringing the monitor (not depicted) closer to the user. Likewise, FIG. 3 shows the work platform 2 moving in the backward direction B, increasing the distance between the monitor and the user.

The control circuit 31 can receive the set distance and set time parameters and control the motor 337 accordingly. In some embodiment, the control circuit 31 can be implemented by one or more of a microprocessor, a microcontroller, a digital signal processor, a microcomputer, a central processing unit, a field programmable gate array, a programmable logic device, a logic circuit, an analog circuit, a digital circuit, and/or any processing element that operates signals based on operation instructions.

Referring FIGS. 1 and 5 together, the adjustable monitor stand system further includes an optical sensor 319. The optical sensor 319 is electrically coupled to the control circuit 31 and mounted on the base 1.

In one embodiment, the optical sensor 319 can detect the presence of a user in front of the base 1. When the optical sensor 319 detects that the user is present, the control circuit 31 can automatically activate the movement of the work platform 2 according to the set parameters. If the user steps away, the control circuit 31 deactivates the movement to conserve energy and reduce unnecessary wear on the system.

In another embodiment, the optical sensor 319 can also detect and measure the distance between the base 1 and the user. The control circuit 31 can compare this distance to a predefined minimum distance stored in memory unit. For example, the predefined minimum distance is, but not limited to, 62 cm. If the user's distance from the base 1 is less than the predefined minimum, indicating that the user is too close to the monitor, the control circuit 31 commands the motor 337 to move the work platform 2 backward. This automatic adjustment helps maintain optimal viewing distance, promoting better ergonomics and reducing eye strain.

In some embodiments, the control circuit 31 can further monitor how long the user has been in front of the system. If the optical sensor 319 detects that the user has been present for longer than a set duration, such as 45 minutes, the control circuit 31 can move the work platform 2 back and forth twice by a short distance, creating a gentle vibration effect. This gentle movement serves as a reminder for the user to take a break, encouraging healthy usage habits.

The set distance and set time parameters can be customized by the user through an interface on the adjustable monitor stand system or via an app on a smartphone. This interface may include buttons, a touchscreen, or connectivity to a computer software application that allows for more advanced settings. For example, the monitor stand can interface with computer software to adjust settings based on user profiles, work schedules, or ergonomic assessments.

Accordingly, the adjustable monitor stand system can offer a solution to the limitations of conventional monitor stands by providing automatic adjustments that enhance ergonomics and productivity. By adapting to the user's presence and habits, the system promotes a healthier working environment. In addition, the system is suitable for various settings, including offices, homes, and public spaces where monitors are used. It can accommodate different monitor sizes and weights, making it versatile for a wide range of applications.

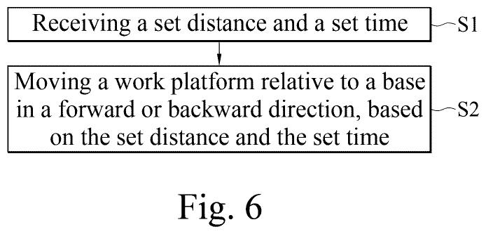

FIG. 6 shows a flowchart of an embodiment of a method for controlling the adjustable monitor stand system. The method includes the following steps:
step S1: receiving a set distance and a set time; and
step S2: moving a work platform relative to a base in a forward or backward direction, based on the set distance and the set time.

The aforementioned steps of the methods can be implemented through one or more embodiments of the adjustable monitor stand system mentioned above, thus avoiding redundant repetition of the technical function, results, and advantages.

In one embodiment, the step S1 of receiving the set distance further includes receiving a forward distance and a backward distance.

In one embodiment, the method further includes steps of detecting a user in front of the base, deactivating a movement of the work platform in absence of the user, and automatically activating the movement when the user is detected.

In one embodiment, the method further includes steps of detecting a distance between the base and the user, comparing the distance to a predefined minimum distance, and moving the work platform in the backward direction if the distance is less than the predefined minimum distance.

In one embodiment, the method further includes steps of moving the work platform back and forth twice by a short distance when detecting that the user has been in front of the base for longer than a set duration to remind the user to take a break.

The technical features, functions and advantages of the embodiments above have been discussed in the previous embodiments, and they are not repeated here to avoid redundancy.

These embodiments address the limitations of conventional monitor stands by offering automatic adjustments that improve ergonomics and productivity. Adapting to user presence and habits, the system offers a healthier work environment. Its versatility supports various monitor sizes and weights, accommodating diverse applications.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

The terms and expressions used herein have the ordinary meaning accorded to such terms and expressions in their respective areas, except where specific meanings have been set forth. Relational terms such as “forward” and “backward” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

1. An adjustable monitor stand system comprising:
a base;
a work platform slidable relative to the base; and
a driving module secured to the base and comprising:
a control circuit adapted for receiving a set distance and a set time; and
a horizontal transmission mechanism coupled to the work platform and adapted for moving the work platform relative to the base in a forward or backward direction based on the set distance and the set time.

2. The adjustable monitor stand system of claim 1, wherein the horizontal transmission mechanism comprises:
a top layer secured to the work platform;
a bottom layer secured to the base;
a sliding element mounted on the top layer and slidable relative to the bottom layer; and
a motor coupled to the sliding element and adapted for controlling a movement of the top layer.

3. The adjustable monitor stand system of claim 1, wherein the base further comprises an optical sensor electrically coupled to the control circuit and adapted for detecting a user in front of the base; and wherein the control circuit can deactivate a movement of the work platform in the absence of the user, and automatically activate the movement when the user is detected.

4. The adjustable monitor stand system of claim 1, wherein the base further comprises an optical sensor electrically coupled to the control circuit and adapted for detecting a distance between the base and the user; and wherein the control circuit can compare the distance to a predefined minimum distance and move the work platform in the backward direction if the distance is less than the predefined minimum distance.

5. The adjustable monitor stand system of claim 1, wherein the base further comprises an optical sensor electrically coupled to the control circuit and adapted for detecting a user in front of the base; and wherein the control circuit can move the work platform back and forth twice by a short distance when the optical sensor detects that the user has been in front of the base for longer than a set duration to remind the user to take a break.

6. A method for controlling an adjustable monitor stand system comprising:
receiving a set distance and a set time; and
moving a work platform relative to a base in a forward or backward direction, based on the set distance and the set time.

7. The method of claim 6, further comprising:
detecting a user in front of the base; and
deactivating a movement of the work platform in absence of the user, and automatically activating the movement when the user is detected.

8. The method of claim 6, further comprising:
detecting a distance between the base and the user;
comparing the distance to a predefined minimum distance; and
moving the work platform in the backward direction if the distance is less than the predefined minimum distance.

9. The method of claim 6, wherein the set distance includes a forward distance and a backward distance.

10. The method of claim 6, further comprising:
moving the work platform back and forth twice by a short distance when detecting that the user has been in front of the base for longer than a set duration to remind the user to take a break.
